(19) United States
(12) Patent Application Publication
(10) Pub. No.: US 2003/0102589 A1
(43) Pub. Date: Jun. 5, 2003

(54) Interacting edging block business model algorithm

(76) Inventor: Ross E. Waltz, Reno, NV (US)

Correspondence Address: Herbert C. Schulze, 2790 Wrondel Way, # PMB36, Reno, NV, 89502, US

(21) Appl. No.: 10/021,650

(22) Filed: Dec. 11, 2001

Related U.S. Application Data
(63) Continuation-in-part of application No. 09/448,274, filed on Nov. 24, 1999, now abandoned.

(51) Int. Cl. B28B 1/08

(52) U.S. Cl. 264/71; 425/457

(57) ABSTRACT

A business model algorithm and an apparatus for forming landscape edging blocks in which preforms of a dry concrete mix is first formed into a preform after which the preform is formed under pressure into an edging block shaped so as to nest with like edging blocks in such manner that a continuous edging may be formed in linear or non linear shapes.

### CROSS REFERENCE TO RELATED PATENT APPLICATIONS

This application is related to, and is a continuation in part, of my co-pending application for Block Manufacturing Method and Apparatus, Ser. No. 09/448,274 filed 1/24/99, now ______. The within application is also related to my U.S. Pat. No. 5,119,587 in that it is a method for making an edging block similar to the blocks disclosed in my said patent.

### BACKGROUND OF THE INVENTION

I. Field of the Invention

This invention is in the general fields of masonry blocks and shapes and landscape edging;

The invention is more particularly in the field of masonry landscaping edging blocks;

The invention is more particularly in the field of landscape edging blacks which are capable of interacting to form continuous linear and non-linear edging;

The invention is even more particularly in the field of a novel, unique, and useful business model algorithm for conducting the business of making interacting edging blocks.

II. Description of the Prior Art

There is much prior art in the field of edging blocks including interconnecting blocks of various types and in the manufacture of concrete blocks and the like.

Some examples of the prior art in landscape edging will be found in the following United States Patents:

U.S. Patent No. D411,315. This is a stackable edging block which does not give any details of manufacture, but which appears probably to be made in a conventional manner;

U.S. Pat. No. 5,414,956; U.S. Pat. No. 5,375,369; U.S. Pat. No. 4,761,923 and U.S. Pat. No. 5,711,106 all show various types of edging.

U.S. Pat. No. 5,827,015 defines a method of making concrete blocks which is interesting, but it does not contain, suggest, nor anticipate the unique and novel features of my present invention.

Each of the following United States Patents defines some general or limited steps in making concrete blocks and the like. However, taken together and/or individually they do not anticipate the useful, unique, and novel business model algorithm and other features of my present invention:

U.S. Pat. No. 4,225,545; U.S. Pat. No. 3,639,555; U.S. Pat. No. 5,779,957; U.S. Pat. No. 2,219,606; U.S. Pat. No. 3,060,542; and U.S. Patent No. Re. 24,527.

None of the prior art of which I am aware anticipates nor suggests my present business model algorithm for the business of providing interacting edging blocks. I believe there is no true prior art of a business model algorithm such as I describe herein.

### SUMMARY OF THE INVENTION

In landscaping, garden maintenance, and the like, there are many requirements for edgings to define areas around trees, natural formations, various plants, lawns, garden designs and the like.

Edgings generally are formed of wood, bricks, plastic members of various types, concrete blocks, and the like. Particularly desirable edgings are described in my heretofore mentioned U.S. Pat. No. 5,119,587. The various edgings described in my patent are desirable because they are made of concrete, and thus quite durable in gardens and the like, and they are shaped so as to be able to be formed into attractive, self engaging linear and non-linear arrangements and shapes so as to accommodate most desired edging patterns.

One problem with these blocks, however, is difficulty in manufacturing them economically, since their shapes are difficult to manufacture. If the blocks are readily able to conform to mold patterns and pressures, they will slump if removed from the mold quickly. On the other hand, if they are formed dry enough for immediate removal from the mold, it becomes almost impossible to apply sufficient pressure to form the items properly since the dry mixture resists flowing into the shape of a mold or die.

I previously believed that I had solved the problem by the methods outlined in my previously mentioned co-pending patent application. However, I continued to work and experiment and have now determined that while my previous methods were an advance in the art, there was still some desirable improvement in order to achieve a true business model algorithm for successfully conducting a business of making, or manufacturing, interacting edging blocks.

I have now perfected my efforts and ideas into an easily duplicated business model algorithm. This is very important, since due to the weight of these products, it is not economically possible to manufacture these interacting blocks in a single location and ship them to all locations in which they will be used.

Now, it is only necessary for maximum usage and supply that the present business model algorithm be followed and duplicated at many locations, each of which an economically serve a limited geographical area.

I have now solved this problem by creating a business model algorithm which optimizes the effectiveness of the materials used and minimizes the cost of the interacting edging blocks. The first step in my algorithm involves making a relatively dry mix of cement, aggregate, and water in a manner and proportions such that I have been able to achieve desirable compressive strength of the finished edging blocks at two thousand pounds per square inch. This strength is generally not possible from accelerated production with a minimum quantity of cement (the most expensive ingredient).

However, in utilizing my new business model algorithm for interacting edging blocks I have maximized performance by using specific percentages of material, special preforming techniques, and special compressing dies. This business model algorithm also results in high production rates with inexpensive equipment and minimal labor cost.

In the past it has not generally believed that a dry granular mix could be utilized to create useable interacting edging blocks, let alone blocks with superior qualities such as the ability to meet a compression test of two thousand pounds per square inch using a mix with only one part by volume of cement to one part water and eight parts aggregate. Approximately five percent of the final mix may be color (oxides, as is known to those skilled in the art) which may be substituted for that amount of aggregate. An important part of the algorithm is the use of special compacted preforms of the mix in special shapes which allows for die forming under pressure in a mold having the appropriate pressure applied. In this manner, the blocks are properly formed and are immediately removed from the dies. The special preform shape I have devised is a somewhat pyramidal shape. I form the individual preform shapes either in a unique and novel mold and method or by a unique and novel extrusion method.

It is an object of this invention to provide a method and apparatus to form concrete into special shapes;

Another object of this invention is to provide such a method and apparatus which can form the shapes from relatively dry concrete mixtures;

Another object of this invention is to provide such a method and apparatus wherein a specially shaped preform of the concrete mixture is made prior to final formation of the finished shape;

Another object of this invention is to provide a method and apparatus suitable to manufacture inter-acting landscape edging material.

The foregoing and other objects and advantages of this invention will become apparent to those skilled in the art upon reading the following description of a preferred embodiment in conjunction with a review of the appended drawings.

### BRIEF DESCRIPTION OF THE DRAWINGS

FIG. 1 is a schematic perspective of an edging block made by business model algorithm of this invention with a phantom of another like block showing the manner in which the blocks interact;

FIG. 2 is a schematic perspective of a preform container suitable to be used in practicing the algorithm of this invention;

FIG. 3 is a schematic perspective of a preform made in practicing the method of this invention resting on a carrying plate ready to be shaped into the finished edging block shape;

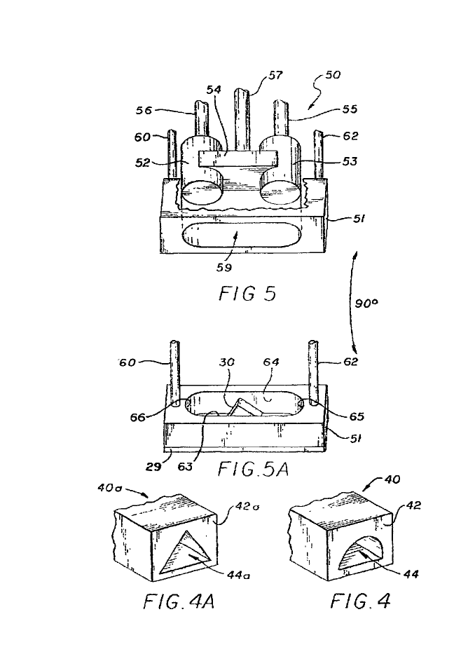

FIG. 2a is a schematic perspective of an alternate preform container suitable to be used in the algorithm of this invention;

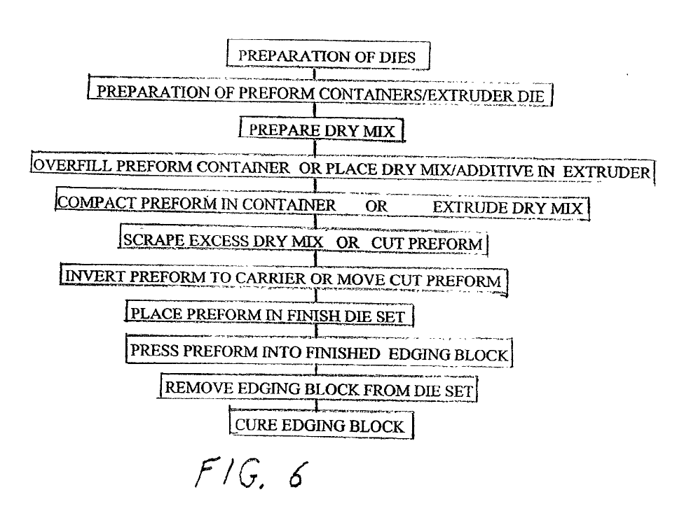

FIG. 3a is a schematic perspective of a preform made with the preform mold of FIG. 2a resting on a carrying plate ready to be pressed into the finished edging block shape;

FIG. 4 is a schematic perspective front end view of an extrusion die suitable to make a preform as an alternate step in this algorithm;

FIG. 4a is a schematic perspective front end view of an alternate extrusion die suitable to make a preform as an alternate step in the algorithm of this invention;

FIG. 5 is a partly broken away schematic perspective of dies suitable to practice the pressure forming steps of this algorithm;

FIG. 5A is a schematic perspective of the lower die of FIG. 5 rotated ninety degrees from the position in FIG. 5 and with the pressure dies removed; and

FIG. 6 is a block diagram of the steps involved in the business model algorithm of this invention.

### DESCRIPTION OF A PREFERRED EMBODIMENT

The items bearing reference numerals on the drawings are:

| Numeral | Item |
|---|---|
| 10 | finished edging block |
| 10a | edging block in phantom |
| 11 | semi-circular vertical surface |
| 12 | semi-circular vertical surface |
| 13 | semi-circular vertical surface |
| 14 | semi-circular vertical surface |
| 14a | phantom semi-circular vertical surface |
| 15 | raised portion between semi-circular vertical surfaces |
| 16 | horizontal circular surface |
| 17 | horizontal circular surface |
| 17a | phantom horizontal circular surface |
| 20 | preform container |
| 21 | preform container open top |
| 22 | preform container right end |
| 22a | top edge of preform container right end |
| 24 | preform container semi-circular body |
| 24a | top edge of preform container back |
| 24b | top edge of preform container front |
| 26 | preform container left end |
| 26a | top edge of preform container left end |
| 29 | preform carrying plate |
| 20a | alternate preform container |
| 21a | alternate preform container open top |
| 22a | alternate preform container right side |
| 22aa | top edge of preform container right side |
| 24a | alternate preform container back side |
| 24aa | top edge of preform container back side |
| 26a | alternate preform container left side |
| 26aa | top edge of alternate preform container left side |
| 27a | alternate preform container front side |
| 27aa | top edge of alternate preform container front side |
| 28a | alternate preform container closed end |
| 29a | alternate preform carrying plate |
| 30 | preform |
| 31 | preform bottom |
| 32 | preform front end |
| 36 | preform right side |
| 38 | preform top surface |
| 30a | alternate preform |
| 31a | alternate preform bottom |
| 32a | alternate preform front side |
| 34a | alternate preform left side |
| 36a | alternate preform back side |
| 37a | alternate preform right side |
| 38a | alternate preform top |
| 40 | extrusion die |
| 42 | front of extrusion die |
| 44 | extrusion die discharge opening |
| 40a | alternate extrusion die |
| 42a | front of alternate extrusion die |
| 44a | alternate extrusion die discharge opening |
| 50 | finish top die |
| 51 | finish bottom die |
| 52 | cylindrical forming die |
| 53 | cylindrical forming die |
| 54 | steel block |
| 55 | hydraulic cylinder shaft |
| 56 | hydraulic cylinder shaft |
| 57 | hydraulic cylinder shaft |
| 58 | opening through block 51 |
| 59 | block insert mechanism |
| 60 | finish top die activating shaft |
| 62 | finish top die activating shaft |
| 63 | vertical cavity wall |
| 64 | vertical cavity wall |
| 65 | semi-circular cavity end |
| 66 | semi-circular cavity end |

The edging blocks formed by the algorithm and with the apparatus of this invention are formed of a mixture of aggregate, portland cement and water. The aggregate I will generally use will be sand. However, other aggregates such as pea gravel and sand or other materials than gravel and sand or the like might be used without departing from the inventive principles revealed in this patent application. Additionally it may be that other materials could be substituted for the portland cement and water without departing from the intentions herein shown and described.

In this patent application I will use the words “dry”, “dry mix” or other such terms. I mean by this using a very minimum amount of water. As I have mentioned above I am able to use very economical mixtures and still get outstanding quality with my algorithm. I have found that a satisfactory mix can be in the proportion, by volume, of one part water to one part portland cement to eight parts aggregate (usually medium grain size sand) on a clear spring day in Reno, Nev. The amounts may vary under different climatic conditions and depending upon water characteristics, type of aggregate, etc. One skilled in the art can make adjustments as necessary by simple experimentation

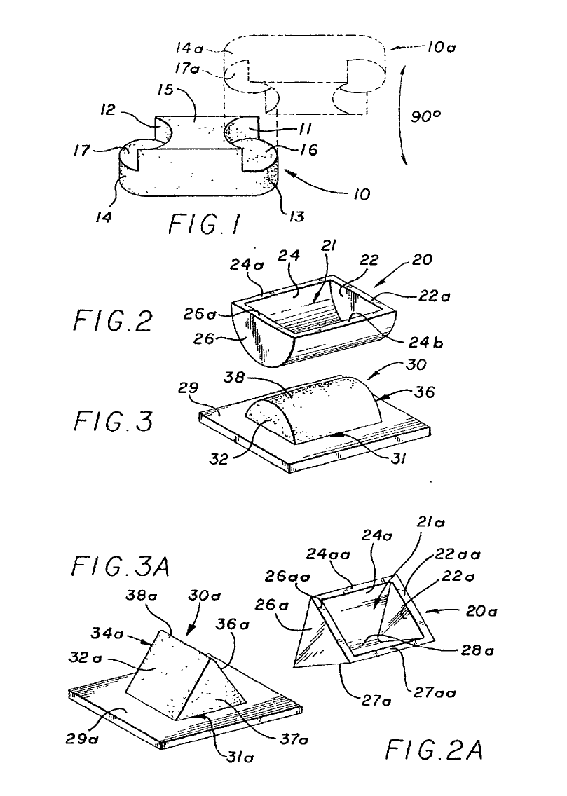

FIG. 1 is a perspective of an edging block 10 made by the algorithm, and with the apparatus, of this invention. The block consists of an elongate oval shape having semicircular ends 13 and 14 with horizontal flat circular surfaces 16 and 17 respectively. Each of ends 13 and 14 is one-half the thickness of the block center portion 15. The thick center portion 15 has semi-circular surfaces 11 and 12 at the ends of its thickened portion 15. The block 10a, shown in phantom, illustrates the manner in which the blocks are placed in use. The flat circular surface 17a will rest upon flat circular surface 16. The outer surface of end 14a will mate with the surface 11. Thus, the blocks will create an edging of any length with uniform thickness. The edging can be laid in a straight line, or may be turned, due to the semicircular mating of the blocks, so as to create non linear edging as desired.

I found that it was not feasible to produce these blocks by using a customary wet concrete mixture, as the blocks would slump if removed from the molds quickly, and the cost of multiple dies and the time lost made it impractical to form the blocks in a customary manner.

Next, I found that attempts to dry press the blocks were not practical using ordinary methods, as the drier material would not flow under pressure so as properly to fill the uniquely shaped mating block dies.

I solved this problem by making a preform of the block material shaped so that the dry material will flow to conform to the finish mold and die combination. The two preferred shapes are a semi-cylindrical shape and a pyramid-like shape as illustrated in FIGS. 3 and 3A. In these shapes, using the correct amount of material in the dies and by proceeding in the manner hereafter described, I am able to make satisfactory dry pressed blocks which are removed immediately from the dies with no slumping or other adverse result. In fact, making the blocks according to the algorithm of this invention results in unusually high quality with a compression strength of two thousand pounds per square inch. The reason this is possible is that the unique preform allows sufficient movement of the relatively dry mixture to properly fill the die cavities and to conform to the shape of the finish die and the pressure die which are described below.

The very first step in my algorithm is the preparation of the dies (finish die set) as illustrated in FIGS. 5 and 5A, and described below, and as will be clear to those skilled in the art.

The second step is to make a preform container or preform extrusion die as shown by FIG. 2, FIG. 2A, FIG. 4, and FIG. 4A.

FIGS. 2 and 3 illustrate schematically a preferred container I use to make a preferred preform and the preform itself located on a carrying plate which will ultimately be placed beneath the finish die for the pressing and completion of the edging block as described below. The preform container 20 is a semi-cylindrical shape and comprises ends 22 and 26 and semi-cylindrical body 24. The top 21 of the container 20 is open. The right and left ends 22 and 26 at the top 21 preferably will flare out slightly from one another as compared to the bottom, the lowest point of the semi-cylindrical body, in order to facilitate removal of the container from the preform.

When the foregoing described equipment is on hand, a dry mixture of material is prepared by mixing, by volume, one part portland cement or the like, one part water, and eight parts aggregate, preferably sand or the like. This is mixed in any customary manner such as by tumbling in a cement mixer with the water preferably sprayed into the tumbling sand and cement.

In practice, the container 20 is filled with the concrete dry mixture in an amount in excess of that exactly required to result in the finished block. The excess material is in a mound over the top of the upper edges 22a, 24a, 24b, and 26a of the preform container. The container 20 is then vibrated to compact the material in the preform container. The excess material remaining after the vibrating is scraped off so that the top of the compacted material is now flat in a plane with the container upper edges 22a, 24a, 24b and 26a. The container is then inverted onto the preform carrying plate 29. The container is next lifted off of the preform and the preform 30 is ready for the next step in the process. The preform 30 has a right end 36, left end 32, and semi-circular top surface 38.

FIGS. 2A and 3A illustrate schematically the container I use to make an alternate preform and the alternate preform itself located on a carrying plate which will ultimately be placed beneath the finish die for the pressing and completion of the edging block as described below. The alternate preform container 20 is an inverted pyramid-like shape and comprises ends 22 and 26 and sides 24 and 27. the sides 24 and 27 are joined at 28 to make an essentially “v” shape cross section. At the very bottom 28, the joinder of the sides 27 and 24 is somewhat rounded so that the top 38 of the preform will be rounded or flattened. The top 21 of the container 20 is open. The right and left ends 22 and 26 at the top 21 preferably will flare out slightly from one another as compared to the bottom 28 in order to facilitate removal of the container from the alternate preform.

In practice, the alternate preform is made like the previously described preform, but the steps will be detailed again. The container 20a is filled with the concrete dry mix in an amount in excess of that exactly required to result in the finished block. The excess material is in a mound over the top of the upper edges 22aa, 24aa, 26aa and 27aa of the preform container. The container 20a is then vibrated to compact the material in the preform mold. The excess material remaining after the vibrating is scraped off so that the top of the compacted material is now flat in a plane with the container upper edges 22aa, 24aa, 26aa and 27aa. The container is then inverted onto the preform carrying plate 29. The container is next lifted off of the preform and the preform 30a is ready for the next step in the process. The preform 30a has a right side 37a, left side 34a, front side 32a, back side 36a, bottom 31a, and top 38a.

Extrusion (FIG. 4) is an alternate method to form the preforms. In this case, the dry mix material is forced through extrusion die 40 and out of extrusion die discharge opening 44 at the front 42 of the extrusion die. The extrusion mechanism can be any extrusion system such as a screw, a piston, or the like as will be known to those skilled in the art. It has normally been thought that the dry mix would not extrude well and the possibility of extrusion was ignored. I have now discovered that by adding a small amount of sodium silicate or the like I am able to provide sufficient lubricating and flowing characteristics. Using extrusion, a knife or the like (not shown, but known to those skilled in the art) will cut a sufficient length to form a proper preform at the front 42 of the die 40. This extruded preform will be formed in the same shape as previously described.

Extrusion will also be possible for the alternate preform described above. In this case, the dry mix material is forced through extrusion die 40a and out of extrusion die discharge opening 44a at the front 42a of the extrusion die. Again, the extrusion mechanism can be any extrusion system such as a screw, a piston, or the like as will be known to those skilled in the art. Also, as previously mentioned, a small amount of sodium silicate or the like will provide sufficient lubricating and flowing characteristics. A knife or the like (not shown, but known to those skilled in the art) will cut a sufficient length to form a proper preform at the front 42a of the die 40a. This extruded preform will be formed in the same shape as previously described.

FIGS. 5 and SA are best viewed together. The finish die 51 is a block of steel or the like with an elongated cavity 59 extending completely through die. The cavity 59 is in the shape of an elongate oval having vertical semi-circular right and left ends 65 and 66. The vertical front and back cavity straight walls 63 and 64 complete the elongate oval cavity 59. A pair of connecting arms 60 and 62 or the like are actuated by hydraulic, or other, means known to those skilled in the art to raise or lower the finish die, The finish top die assembly 50 comprises a steel or the like block 54 shaped like the raised portion 15 of the finished edging block 10. Two cylindrical forming dies 52 and 53 nest in sliding engagement with block 54 and the cavity 59 through finish die 51 as shown. Cavity 59 has vertical cavity walls 63 and 64 and semi-circular cavity ends 65 and 66.

In operation, the preform 30 on carrying plate 29 is placed on a platform (not shown, but understood by those skilled in the art) under the center of mold cavity 59. At this time the finish die and forming die assembly are in a position vertically above the carrying plate and the preform. Hydraulic cylinders or the like (not shown, but understood by those skilled in the art) are activated to move shafts 55, 56, 57, 60 and 62 carrying finish die 51 and forming dies 52, 53 and 54. The finish die 51 will press down on plate 29, with preform 30 being centered within the elongated oval cavity 59. Forming dies 52, 53, and 54 will press down on the preform, deforming it into the exact shape of the finished block 10. At the same time the entire die may be subjected to heavy vibration in a manner known to those skilled in the art to assist in the forming of the finished edging block 10. This pressing (and vibration) forms the preform 30 into a cohesive article in the shape of the finished edging block 10. The forming dies 52 and 53 will move deeper into cavity 49 than will the block 54, thus forming the preform into the shape of the finished block 10. On completion of the forming, the entire finish die 51 is lifted. The dies 52 and 53 are next lifted. The final lifting is the lifting of die 54. The foregoing sequence is important, since the edging block may be destroyed due to vacuum pressures if the sequence is otherwise. The formed, but uncured, edging block is then removed from the plate 29 and the apparatus is ready for the next, identical, series of operations. Thereafter, the block is allowed to cure as is known to those skilled in the art.

FIG. 6 shows the steps which are taken in this method of manufacturing blocks: I) cement and aggregate are mixed in a customary manner; II) water is added; III) the preform container is over-filled with the mixture from step II; IV) the preform is compacted by vibrating the preform mold and excess material is scraped off the top; V) the compacted preform in the preform container is inverted and the preform container is removed from the preform; VI) the compacted preform on its carrying plate is placed under the approximate center of the elevated finish die cavity; VII) the finish die is lowered over the preform and the forming dies are pressed onto the preform (the mechanism may be vibrated); VIII) the finish die and the forming dies are removed from the formed edging block; IX) The formed block is removed from the carrying plate; and X) the formed block is cured. The curing step may be merely the passage of time until the cement has set so that the block may be used safely, or the curing may be special curing under various conditions as is known to those skilled in the art.

Where the preform is made by extrusion, steps II through V are replaced by steps IIa through Va as follows: IIa) water and additive (sodium silicate or the like) are added to the aggregate and cement (The water and aggregate proportions will be the same as in step II, with an amount of sodium silicate or the like equal to 10% of the amount of water being added; IIIa) the mixture will be placed in the extruder; IVa) the extruder will be activated to force material through the extrusion die; and Va) the desired length to form the proper preform will be cut from the material being extruded through the extrusion die.

I have described particular preform container and die arrangements; specific methods of forming the preform utilized in practicing the method of this invention; as well as certain other details. While these details may be preferred, it is not my intention to be limited where an equivalent may be employed. For examples: cam action or other means might be employed instead of hydraulic activation of the dies without departing from the inventive principles concerned; or a one piece die in the appropriate desired shape of the finished product might be used rather than the dies as illustrated and described above without departing from the inventive principles concerned. Other such equivalents may occur to those skilled in the art without departing from the inventive principles concerned.

While the embodiments of this invention shown and described are fully capable of achieving the objects and advantages desired, it is to be understood that these embodiments have been shown for purposes of illustration only, and not for purposes of limitation.

In the claims which follow, if I fail to claim any patentable feature of this invention, such failure to claim any such feature will be due to inadvertence, and is not intended to be a dedication or abandonment of such feature. In the event of any such failure to claim, I intend to claim such feature by reissue or any other appropriate action upon discovering such failure to claim.

I claim:

1. The business model algorithm for preparation of a shaped block from an aggregate material comprising the following steps: I) at least one shaped block finish die set and preform container are prepared; II) a quantity of dry mix aggregate material is prepared; III) a preform is prepared using a preform container or an extruder; IV) the preform is placed into the finish die set; V) pressure is applied to the finished die set to force the preform into the final shape of the shaped block; VI) the shaped block is removed from the finish die set; and VII) the shaped block is cured.

2. The algorithm of claim 1 in which the dry mix aggregate material preform is in a semi-cylindrical shape.

3. The algorithm of claim 1 in which the dry mix aggregate material preform is in a pyramid-like shape.

4. Apparatus for forming landscape edging blocks comprising: dry mix preform forming means; moveable die set means having an interior cavity configured so as to have an initial interior cavity larger than a final interior cavity which final interior cavity is the same shape and dimensions as the exterior of an interacting edging block; means for placing a preform in the die set means; means for moving said die set means in such manner as to reconfigure the preform so as to have the exterior shape and dimensions identical to the final interior cavity configuration of the die set means; and means for removing the reconfigured preform from the die set means.

5. The apparatus of claim 5 wherein the die set means has two circular end platforms with a raised center having semicircular end concavities.
